(19) United States
(12) Patent Application Publication
(10) Pub. No.: US 2011/0186793 A1
(43) Pub. Date: Aug. 4, 2011

(54) Handicap wheel chair lifter

(76) Inventors: Rafael Colon O'Neill, Miami, FL (US); Umberto Antonio Cerdido Baculo, (US)

(21) Appl. No.: 12/658,040

(22) Filed: Feb. 1, 2010

(51) Int. Cl. B66F 11/00

(52) U.S. Cl. 254/1

(57) ABSTRACT

A wheel chair lifting structure to safely accommodate a plurality of wheel chairs sizes and their occupants that includes securing, lifting and lowering devices.

### CROSS REFERENCE TO RELATED APPLICATIONS

Not Applicable.

### FEDERALLY SPONSORED RESEARCH

Not Applicable

### SEQUENCE LISTING PROGRAM

Not Applicable

### BACKGROUND

### FIELD OF INVENTION

This invention relates to wheel chair lifting devices.

Background. Prior. art: not known prior art.

### SUMMARY

In accordance to one embodiment a wheel chair lifting device that includes a body configuration as to fit multiple sizes of wheel chairs as well as means of lifting and securing said wheel chairs.

### DRAWING FIGURES

FIG. 1. shows one embodiment of present invention in an uppermost elevated position in a perspective view.

FIG. 2. shows one embodiment of present invention and accompanying wheel chair in an elevated position in a sideelevational position.

FIG. 3. show one embodiment of present invention in a lowermost position at floor level in a perspective view.

FIG. 4. shows one embodiment of present invention in a side elevational cut view at floor level.

10 Wheel chair horizontal support

12 wheels guard rails

14 wheels rear stop

16 wheels front stop

18 wheel stop pin orifice

20 wheels stop retaining pin

22 head rest

24 back rest

26 lifting device

28 floor level

30 wheel chair

32 present invention

### OBJECT

The object of this invention is to provide a wheel chair lifting device to accommodate different sizes of wheel chairs to be used in medical, dental and hair saloon facilities, among others, that permits to take care of handicapped persons in their own wheelchairs preventing discomfort while saving time and effort.

### DETAILED DESCRIPTION

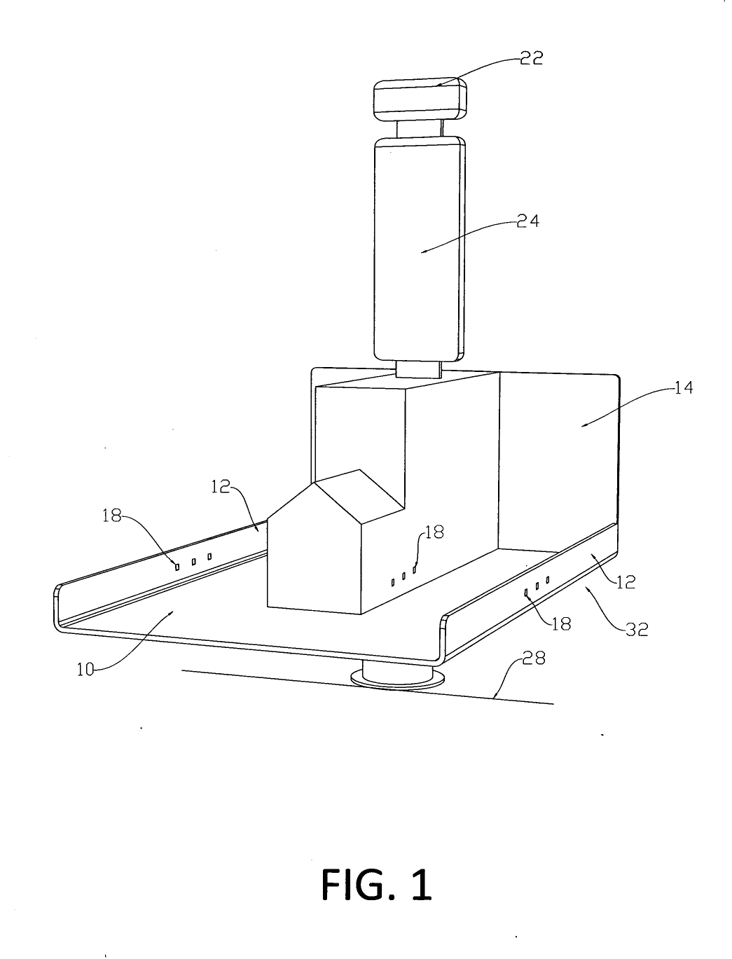

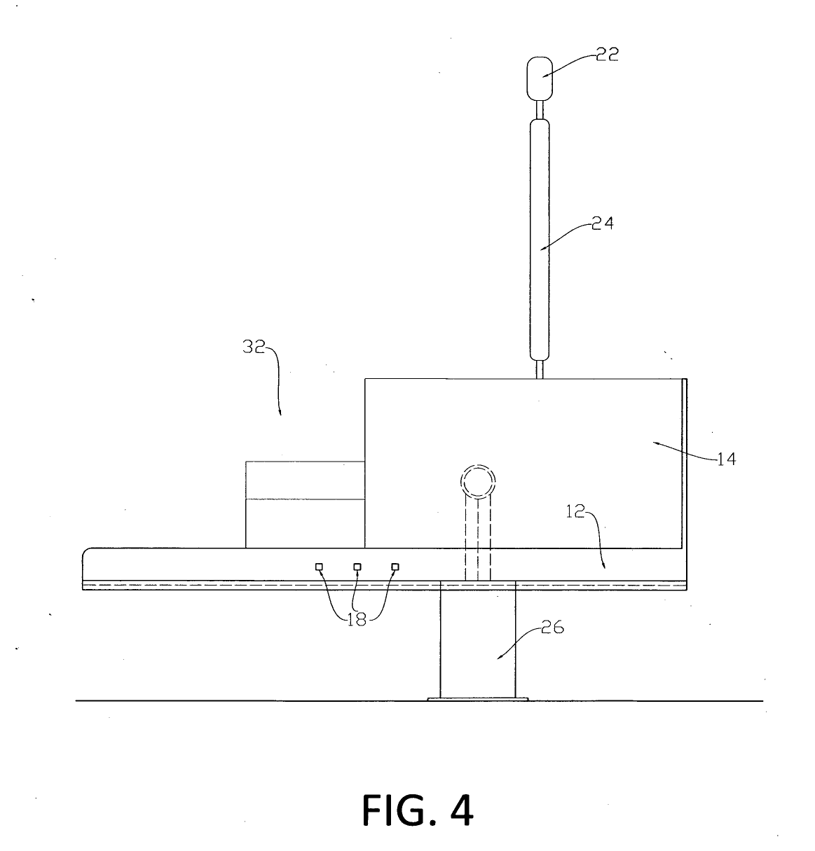

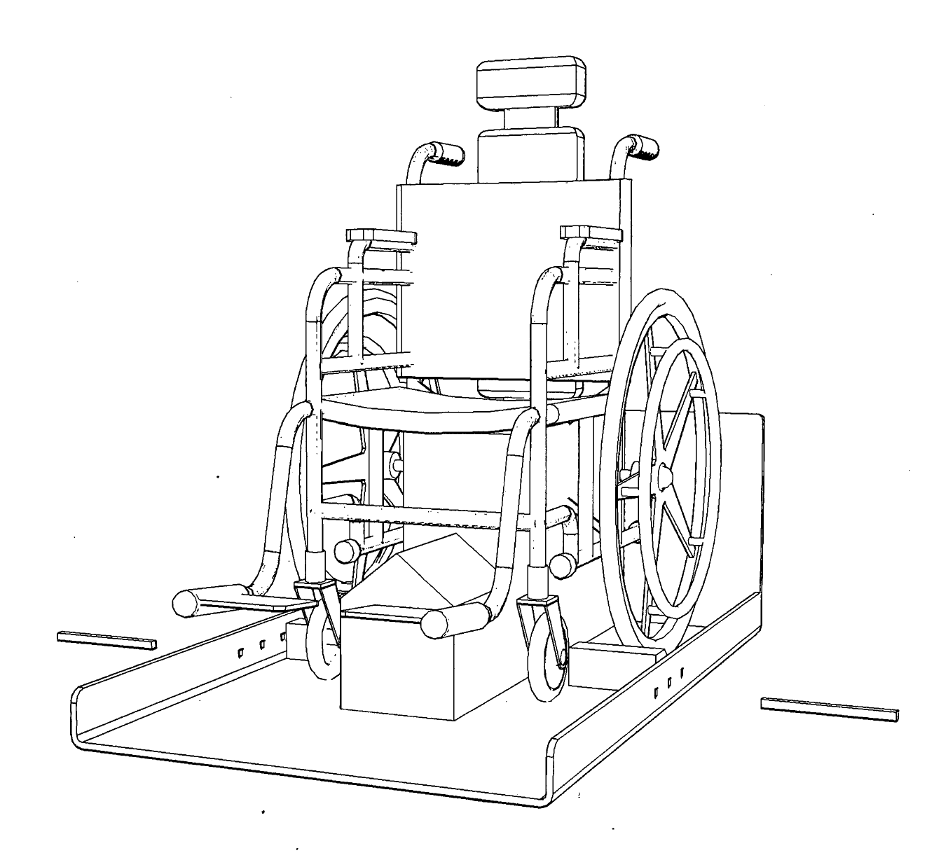

One embodiment of present invention is illustrated in FIGS. 1 to 4 showing a structure of rigid body of material shaped to accommodate multiple sizes of wheel chairs and designated with numeral 32, said structure includes horizontal supports 10, guard rails 12, multiple orifices 18 to receive retaining pin 20 which passing thru wheel stop 16 secures wheel in place preventing any unwanted wheel rotation during lifting or lowering operation.

Further said structure 32 comprises means of attachment of lifting device 26 at a predetermined location.

Furthermore structure 32 comprises means of attachments for adjust able back rest 24 and head rest 22 at predetermined locations.

Operation:

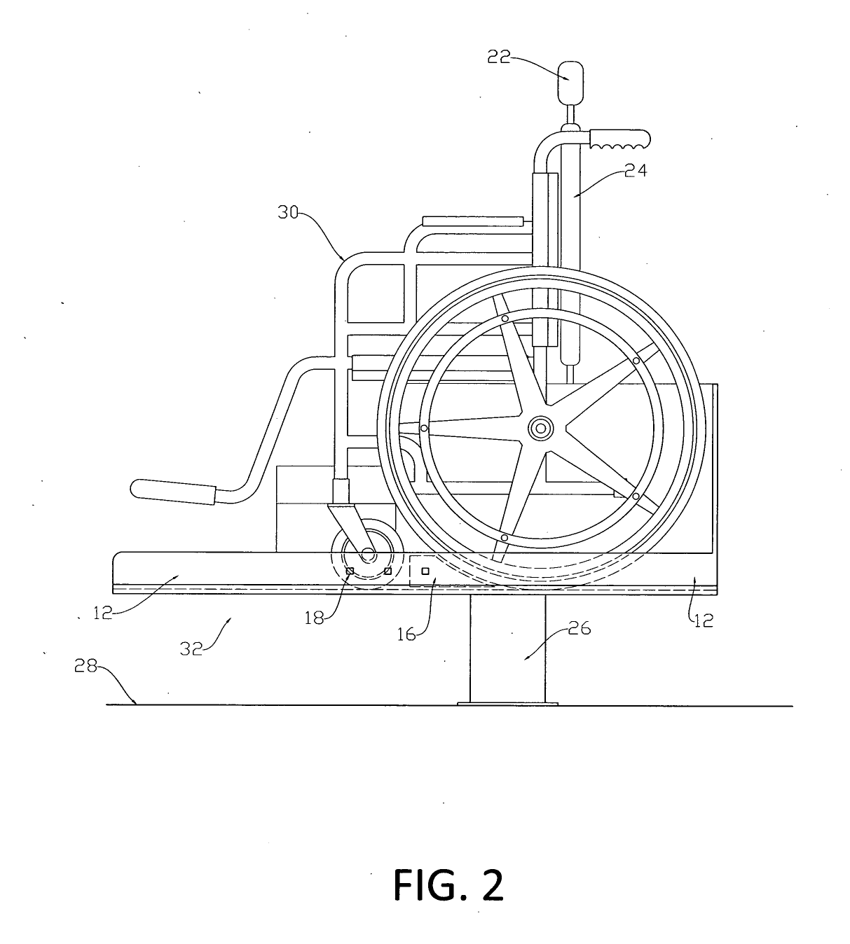

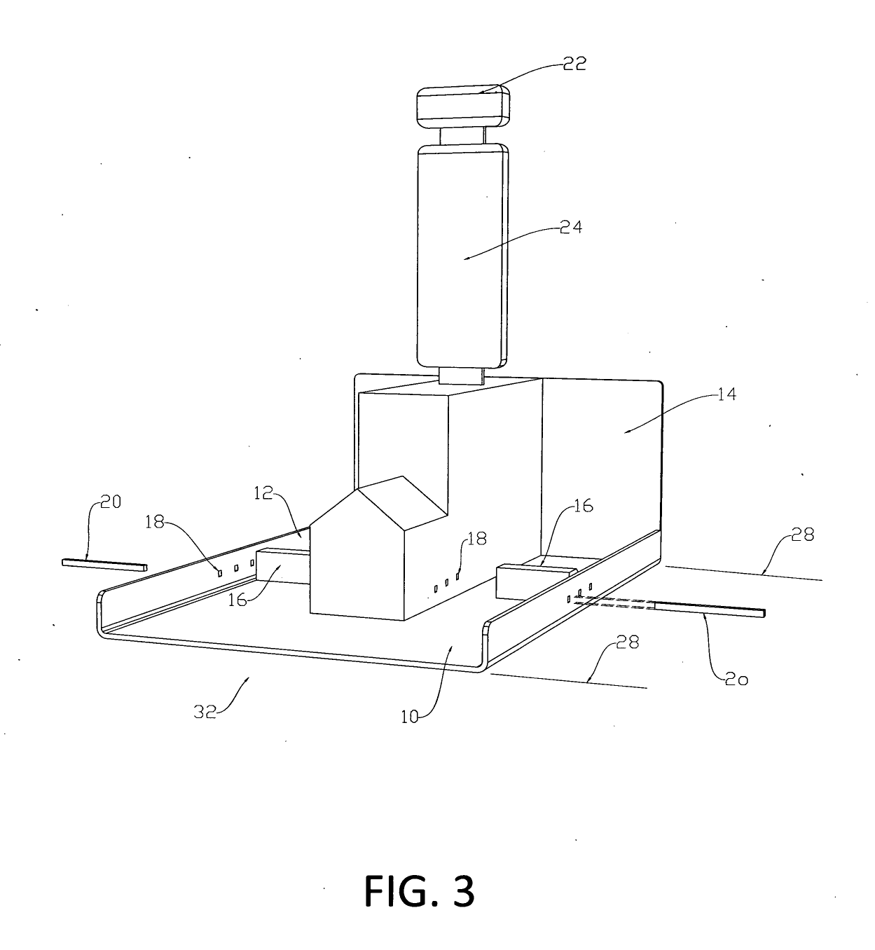

The manner of using present invention is to lower structure 32 in to its lowermost position and in contact with floor level 28 as in FIG. 3, wheel chair 30 and its occupant are wheeled in to said structure thru wheels horizontal supports 10 in a backward motion as to stop against rear stop 14 as in FIG. 2, at this point wheel stop 16 is installed in both wheels and securely retained thru retaining pin 20, lastly desired height may be attained by operating lifting device 26.

Advantages

From the above description and accompanying drawings a number of advantages are present by the proper use of this indention;

1—prevents the unnecessary relocation of a handicapped person from wheel chair to another service chair.

2—Prevents potential injury to the handicapped person when been moved from one chair to another.

3—Minimizes time and effort when in the above described scenario. The foregoing is to be considered as descriptive and illustrative only of the principle of this invention. Further, since numerous modifications and changes are possible and may are likely to occur to those people skilled in the arts, it is not intended to limit this invention to the exact construction, operation and use described, accordingly, all suitable modifications or equivalents may be utilized falling whithing the scope of this invention.

I claim:

1- A handicap wheel chair lifter comprising a body of rigid material of a variable cross sectional area.
a- rigid body of material in claim one includes a predetermined shape and size as to accommodate a plurality of wheel chair sizes,
b- rigid body of material in claim one further including means of attachments of lifting and lowering devices as to be able to lifting and lowering handicapped wheel chairs by they own wheels without affecting said wheel chairs structural integrity.
c- further more rigid body of material in claim one further including means of securing said wheel chairs against any movements during lifting and lowering operations whereby achieving substantial time and effort savings during some of the caring necessities for a handicapped person.
